(19) United States
(12) Patent Application Publication
(10) Pub. No.: US 2003/0065076 A1
(43) Pub. Date: Apr. 3, 2003

(54) Elastomeric compositions

(76) Inventors: Carl Walter von Hellens, Bright's Grove (CA); Sharon X. Guo, Stratford (CA); John Dato, Cuyahoga Falls, OH (US)

Correspondence Address: BAYER CORPORATION, PATENT DEPARTMENT, 100 BAYER ROAD, PITTSBURGH, PA, 15205, US

(21) Appl. No.: 10/234,593

(22) Filed: Sep. 4, 2002

(30) Foreign Application Priority Data
Sep. 7, 2001 (CA) 2,357,089

(51) Int. Cl. C08K 5/04; C08K 3/04

(52) U.S. Cl. 524/397; 524/394; 524/495

(57) ABSTRACT

A novel elastomeric composition containing a hydrogenated carboxylated nitrile rubber, a hydrogenated nitrile rubber, a filler, a multivalent salt of an organic acid and a vulcanizing agent. The composition has good static and dynamic modulus and good abrasion resistance, and is suited for use in pads for tracks of tracked vehicles, for example military vehicles such as tanks.

### FIELD OF THE INVENTION

The present invention relates to a rubber composition having improved properties. These improved properties render the rubber composition useful, for example, for track pads for tracked vehicles such as tanks paving machines, heavy earth-moving equipment and farm tractors.

### BACKGROUND OF THE INVENTION

European Patent Application No. 0 326 394, published Aug. 2, 1989, entitled “Improved rubber compound for tracked vehicle track pads” discloses the demands that are imposed on elastomeric compositions that are used as track pads for military vehicles, especially heavy tonnage tracked vehicles of 40 to 60 tons, and also discloses compositions that are said to meet these demands better than elastomeric compositions previously used for this purpose, namely, styrene-butadiene rubber.

The European application discloses, for use as tank pads, a “unique combination of a polymer system, a filler system, a curing system and an antidegradant system”. The polymer system may be “a highly saturated nitrile rubber”, “a blend of from about 80 to about 90 parts of highly saturated nitrile and from about 10 to about 20 parts of carboxylated nitrile”, or “a blend of from about 45 parts to about 90 parts of highly saturated nitrile, from about 1 to about 5 parts of carboxylated nitrile and from about 5 to about 50 parts of nitrile rubber”. At page 4 lines 56 and 57 it is stated that the polymer “used in this subject invention application rubber formation is a highly hydrogenated nitrile copolymer with slight double bonds”. Therefore, it is clear that by a “highly saturated nitrile” is meant a hydrogenated nitrile rubber. It is said “preferably (to) have a degree of unsaturation ranging between about 1% and about 20%”.

Novel elastomeric compositions that display some properties that are superior to the compositions of EPA 0 326 394 have now been discovered.

### SUMMARY OF THE INVENTION

One aspect the present invention provides a composition containing a hydrogenated carboxylate nitrile rubber (HXNBR), a hydrogenated nitrile rubber (HNBR), a filler, a multivalent salt of an organic acid and a vulcanizing agent.

Another aspect the present invention provides a process for preparing an elastomeric composition which includes blending HXNBR, HNBR, a filler, a multivalent salt of an organic acid and a vulcanizing agent.

### DESCRIPTION OF PREFERRED EMBODIMENTS

The elastomeric composition contains a hydrogenated carboxylated nitrile rubber (HXNBR). The HXNBR is present in an amount in the range of from 10 parts to 40 parts, per hundred parts of rubber (phr), preferably 15 to 30 phr. The HNBR is present in the range of from 90 to 60 phr, preferably 85 to 70 phr. Alternatively, there may also be present an amount in the range of from 10 to 20 phr of a carboxylated nitrile rubber (XNBR). Alternatively, there may also be present nitrile rubber (NBR) and XNBR in addition to the HXNBR and HNBR. When XBR is present, it is present in an amount of 1 to 5 phr and the NBR is present in an amount of 1 to 50 phr. The amount of HXNBR and/or HNBR will have to be decreased accordingly to result in a total of 100%. The total composition will be dependent on the intended use of the compound and can be easily determined by one skilled in the art with a few preliminary experiments.

A hydrogenated carboxylated nitrile rubber, HXNBR, and a process for preparing it are disclosed in WO 2001/77185, which is assigned to Bayer Inc. Such rubbers are preferably formed by copolymerizing a conjugated diene, a nitrile and an unsaturated acid, to form a copolymer with a random, or statistical, distribution of the diene, nitrile and acid, followed by hydrogenation. When the diene is polymerized the product contains some carbon-carbon double bonds. In the past attempts to hydrogenate those double bonds have led also to reduction of nitrile and carbonyl groups, which is undesirable. The invention of WO 2001/77185 enables hydrogenation of carbon-carbon double bonds without concomitant reduction of nitrile and carboxyl groups. It is preferred that the hydrogenated carboxylated nitrile rubber used in the present invention is in accordance with WO 2001/77185. Hydrogenated carboxylated nitrile rubbers in accordance with WO 2001/77185 are commercially available from Bayer under the trademark Therban XT.

In the present invention it is preferred that the HXNBR has a nitrile content in the range of from 18 to 45 wt. %, an acid monomer content in the range of from 0.3 to 9 wt. %, an RDB (content of residual double bonds after hydrogenation which might be determined by ¹H-NMR or IR spectroscopy as disclosed in the prior art) of not greater than 9.0% and a Mooney viscosity in the range of from 35 to 120 (ML 1+4′@100° C. according to ASTM test D1646). In one preferred HXNBR, the nitrile is acrylonitrile, the diene is 1,3-butadiene and the acid is acrylic acid.

Nitrile rubbers (NBR's) are preferably copolymers of a conjugated diene and a nitrile. Many conjugated dienes are used in nitrile rubbers and these may all be used in the present invention. Suitable conjugated dienes include 1,3-butadiene, isoprene, 2,3-dimethyl-1,3-butadiene, 1,3-pentadiene and piperylene, of which 1,3-butadiene is preferred.

The nitrile is normally acrylonitrile or methacrylonitrile or α-chloroacrylonitrile, of which acrylonitrile is preferred.

The conjugated diene constitutes in the range of from 50 to 85% of the copolymer and the nitrile preferably constitutes in the range of from 15 to 50% of the copolymer, these percentages being by weight. The polymer may also contain an amount, usually not exceeding 10 wt. %, of one or more other copolymerizable monomers, for example, an ester of an unsaturated acid, such as ethyl, propyl or butyl acrylate or methacrylate, or a vinyl compound, for example, styrene, α-methylstyrene or a corresponding compound bearing an alkyl substituent on the phenyl ring, for instance, a p-alkylstyrene such as p-methylstyrene. Suitable nitrile rubbers are commercially available from Bayer under the trademark Perbunan and Krynac.

Hydrogenated nitrile rubbers (HNBR's) are formed by hydrogenating nitrile rubbers. When a conjugated diene and a nitrile copolymerize the product of the copolymerization still contains carbon-carbon double bonds. These can be hydrogenated in a known manner. Hydrogenation is not always complete, however, and the degree of remaining unsaturation is expressed in terms of residual double bonds, or “RDB”, being the number of carbon-carbon double bonds that remain in the copolymer after hydrogenation, which is expressed as a percentage of the carbon-carbon double bonds present in the copolymer prior to hydrogenation. Hydrogenated nitrile rubbers are available from Bayer under the trademark Therban, with acrylonitrile contents of 34%, 39% and 43% and with RDB's of 18, 5.5, 3.5 and less than 0.9.

Also useful in the present invention is a multivalent salt of an organic acid. Suitable multivalent cations are derived from metals, of which zinc, magnesium, calcium and aluminum are mentioned. Suitable organic acids include saturated and unsaturated acids preferably having up to 8 carbon atoms, more preferably up to 6 carbon atoms. The preferred organic acids are acrylic and methacrylic acids and the preferred salts are zinc diacrylate and zinc dimethacrylate. It is possible to form the salt in situ, but this is not normally preferred. The amount of(the salt used is generally in the range of from 18 to 35 parts by weight per hundred parts of rubber (phr), preferably in the range of from 20 to 30 phr and more preferably between 20 and 25 phr. Even more preferred is zinc diacrylate in an amount of 21-23phr, most preferably 22 phr.

The vulcanizing agent can be any of the known vulcanizing agents, including sulfur vulcanizing agents, but is preferably a peroxide vulcanizing agent. Suitable organic peroxide crosslinking agents include dicumyl peroxide, available under the trademark Dicup 40KE, di-t-butyl peroxide, benzoyl peroxide 2,5-dimethyl-2,5-di(t-butylperoxy)-hexyne-3, 2,5-dimethyl-2,5-di(benzoylperoxy)hexane and a,a-bis(tertiary butylperoxy)diisopropylbenzene, available under the trademark Vulcup 40KE. The preferred curing agent is dicumyl peroxide. The peroxide curing agent is preferably used in an amount of in the range of from 0.2 to 20 phr, more preferably 1 to 10 phr.

The composition of the present invention may contain a filler. This may be, for example, carbon black, silica, calcium carbonate, talc, TiO₂ or other materials known for use as active or inactive fillers in elastomeric compositions. Mention is made of small particle carbon black such as any of those designated as N-110, N-121, N-220 or N-330 by ASTM D-1765 or, alternatively, a medium processed channel black can be used. The amount of filler is preferably in the range of from 1 to 100 phr, more preferably 15 to 25 phr. Mixtures of fillers can be used, and mixtures of carbon black and silica are preferred.

The composition of the present invention may also contain other usual components such as, for example, antioxidants, plasticizers, processing oils, processing aids, waxes, antiozonants, antidegradants, ultra violet absorbers, co-agents and the like. Mention is made of polymerized 1,2-dihydro-2,2,4-trimethylquinoline (TMQ), commercially available under the trademark Vulkanox HS/LG, which can be used in amount of 0.25 to 2 phr. As a plasticizer, there is mentioned trioctyl trimellitate (TOTM), which can be used in an amount from 1 to 5 phr.

The rubbery or elastomeric composition of the present invention can be prepared and compounded using any of the conventional compounding and mixing techniques using conventional rubber processing equipment such as a Banbury mixer or mixing mill. The unvulcanized rubbery composition can then be pre-formed through a rubber extruder and larger amounts or thicknesses can be pre-heated before assembling it with any applicable metal insert subassembly component or plate member with a suitable heat-activated adhesive which can then be placed into a mold for the particular configuration of the article desired, such as a tank track pad, bushing, shoe and/or solid tire or other product.

A vulcanization temperature of at least 160 degrees Celsius should be used to fully activate the peroxide curing system when making the highly improved tank track pads. Premature partial vulcanization should be avoided from the normal or inherent heat generated during the use of the mixing equipment. Therefore, mixing apparatus of a type provided with cooling means is preferably utilized.

As indicated above, the composition of the present invention is suited for use as pads for tracks of tracked vehicles. These include, for example, military vehicles such as tanks, and also heavy earth-moving equipment, paving machines and farm tractors. The high abrasion resistance of the compositions of the present invention also renders them suitable for use in conveyor belts for heavy-duty service at elevated temperature. To illustrate, hot material may be dropped vertically onto a short horizontal conveyor belt, which transfers the material in a horizontal direction, and onto a longer horizontal conveyor. The material of the short horizontal conveyor is subjected to stringent conditions, as it suffers the impact of hot material and also suffers abrasion from the material as it accelerates that material from zero velocity in the horizontal direction. The compositions of the present invention stand up well to these conditions, as compared to other materials used for the same purpose.

Another application of compositions of the present invention is in seals used in drilling in oil wells, where the high abrasion resistance of the compositions is beneficial.

The invention is further illustrated but is not intended to be limited by the following examples in which all parts and percentages are by weight unless otherwise specified.

### EXAMPLES

### Examples 1 to 7

In these examples the HXNBR used had a bound acrylonitrile content of 33 wt. %, an acrylic acid content of 5 wt. %, balance 1,3-butadiene, an RDB of 3.5% and a Mooney viscosity of 77 (ML 1+4′@100° C.). The HNBR was Therban® C3446, available from Bayer, a hydrogenated nitrile rubber with 34% acrylonitrile and an RDB of 4. Sartomer® 633 and 634 are zinc diacrylate and zinc dimethacrylate, respectively. Dicup® 40C is dicumyl peroxide, commercially available in a clay binder coating and containing 40% of active component. TOTM is trioctyl trimellitate plasticizer.

Mixing was carried out in a small Banbury mixer (BR82). Mixing commenced at a temperature of 30° C. and the cooler was supplied with cooling water. Mixer speed was 55 RPM.

The following sequence was used:

| | |
|---|---|
| 0 Seconds | add rubbers and Vulkanox ® HS |
| 30 seconds | add carbon black |
| 90 seconds | add TOTM and zinc diacrylate or zinc |
| | dimethacrylate. |

When the temperature reached 135° C., usually after approximately 6 minutes, the mixture was dumped from the Banbury mixer. The curing agent (and ZnO in Example 1) was then added to the mixture. The mixture was milled on a 10 inch×20 inch mill, with rolls cooled to a temperature of 30° C. for approximately 4 minutes. Thereafter, the rolls of the mill were closed to a very tight mix and the mixture passed through the mix six times.

Results are given in Table 1. Example 1 is a comparative example and in accordance with the teaching of EPA 0 326 394, i.e., no HXNBR is present in the elastomer.

TABLE 1

| Example Number | 1 | 2 | 3 | 4 | 5 | 6 | 7 |
|---|---|---|---|---|---|---|---|
| Therban ® C3467 | 100 | 75 | 75 | 75 | 75 | 75 | 75 |
| HXNBR | | 25 | 25 | 25 | 25 | 25 | 25 |
| Carbon Black N-121 | 20 | 20 | 20 | 20 | 20 | 20 | 20 |
| SR 634 (ZDMA) | 30 | 30 | 25 | 20 | | | |
| SR 633 (ZDA) | | | | 30 | 25 | 20 | |
| Vulkanox ® HS/LG (TMQ) | 0.5 | 0.5 | 0.5 | 0.5 | 0.5 | 0.5 | 0.5 |
| TOTM | 2 | 2 | 2 | 2 | 2 | 2 | 2 |
| DiCup ® 40C | 3 | 3 | 3 | 3 | 3 | 3 | 3 |
| ZnO | 2 | 0 | 0 | 0 | 0 | 0 | 0 |

MDR CURE CHARACTERISTICS
170° C., 1° arc, 100 range

| | | | | | | | |
|---|---|---|---|---|---|---|---|
| MH (dN*m) | 38.25 | 47.44 | 37.20 | 31.48 | 62.79 | 48.31 | 40.09 |
| ML (dN*m) | 2.01 | 2.83 | 2.45 | 2.61 | 2.40 | 2.29 | 2.35 |
| Delta MH − ML (dN*m) | 36.24 | 44.61 | 34.75 | 28.87 | 60.39 | 46.02 | 37.74 |
| ts1 (min) | 1.20 | 1.23 | 1.05 | 0.93 | 1.11 | 0.96 | 0.84 |
| t'50 (min) | 3.15 | 2.55 | 2.13 | 2.02 | 2.55 | 2.14 | 1.89 |
| t'90 (min) | 8.62 | 6.85 | 6.52 | 6.33 | 6.93 | 6.71 | 6.03 |
| STRESS STRAIN | | | | | | | |
| (DUMBELLS) | | | | | | | |
| Cure time @ 170° C. (min) | 16 | 14 | 14 | 13 | 14 | 14 | 13 |
| Test Temperature −23° C. | | | | | | | |
| Stress @ 25 (MPa) | 1.98 | 3.68 | 3.23 | 2.58 | 3.63 | 3.21 | 2.54 |
| Stress @ 50 (MPa) | 2.43 | 4.39 | 3.87 | 3.14 | 4.26 | 4.29 | 3.37 |
| Stress @ 100 (MPa) | 3.15 | 5.75 | 5.12 | 4.06 | 5.44 | 6.54 | 5.05 |
| Stress @ 200 (MPa) | 5.56 | 9.22 | 8.37 | 6.67 | 8.40 | 12.29 | 9.82 |
| Stress @ 300 (MPa) | 9.03 | 12.78 | 11.85 | 9.80 | 11.58 | 18.26 | 15.39 |
| Ultimate Tensile (MPa) | 21.79 | 18.09 | 17.96 | 16.92 | 17.25 | 24.18 | 24.53 |
| Ultimate Elongation (%) | 658 | 535 | 565 | 610 | 569 | 424 | 499 |
| Hard. Shore A2 Inst. (pts.) | 71 | 84 | 80 | 75 | 82 | 79 | 73 |
| M300/M100 | 2.87 | 2.22 | 2.31 | 2.41 | 2.13 | 2.79 | 3.05 |
| DIN Abrasion (mm³) | 90 | 121 | 113 | 107 | 112 | 101 | 80 |
| Picco Abrasion | | | | | | | |
| Abrasive Index (%) | 571.2 | 1013.0 | 765.0 | 660.5 | 908.4 | 1041.1 | 1190.0 |
| Taber Abrasion | | | | | | | |
| 5000 cycles | 0.3362 | 0.3835 | 0.3294 | 0.2575 | 0.3766 | 0.3168 | 0.2437 |
| (Weight Loss-g) | | | | | | | |
| GABO | | | | | | | |
| E′ @ 60° C. (MPa) | 224 | 519 | 456 | 330 | 546 | 401 | 270 |
| E″ @ 60° C. (MPa) | 34.6 | 70.9 | 63.8 | 45.6 | 67.3 | 50.4 | 34.9 |
| Tan Delta | 0.154 | 0.137 | 0.140 | 0.138 | 0.123 | 0.126 | 0.129 |

Abrasion resistance: DIN 53-516 (60 grit Emery paper)
Cure rheometry: ASTM D 52-89 MDR2000E Rheometer at 1° arc and 1.7 Hz

Dynamic Property Testing:

Dynamic testing was carried out using a GABO. The GABO is a dynamic mechanical analyzer for characterizing the properties of vulcanized elastomeric materials. RPA measurements were obtained with an Alpha Technologies RPA 2000 operating at 100° C. at a frequency of 6 cpm.

The compositions of Examples 2 to 7 are significantly superior to the composition of Example 1 in several respects. Thus, the products of Examples 2 to 7 are superior in terms of static modulus, as evident from the higher figures (MPa) for the stress @100. They are also superior in terms of dynamic modulus, as evident from the higher figures for elastic modulus E′@60° C. in the Gabo test. The ratio of static modulus @300 to the static modulus @ 100 (M300/M100) is an approximate indicator of resistance to roadwear, with the higher number indicating greater resistance. It can be seen that the products of Examples 6 and 7 are best in this regard.

Abrasion can occur in different manners and there are different abrasion tests that reflect this. In the DIN abrasion test a low number indicates a better result, and Example 7 is superior in this test to the product of Example 1. In the Picco abrasion test a higher number indicates a better result, and Examples 2 to 7 are superior to Example 1. In the Taber abrasion test a low number indicates a better result, and Examples 3, 4, 6 and 7 are superior to Example 1 in this test.

It is also noteworthy that, in general, results obtained using zinc diacrylate are superior to those obtained using zinc dimethacrylate. Furthermore, tests with lower amounts of zinc diacrylate showed better results in abrasion tests than those with higher amounts of zinc acrylate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition comprising at least one hydrogenated carboxylated nitrile rubber, at least one hydrogenated nitrile rubber, at least one filler, at least one multivalent salt of an organic acid and at least one vulcanizing agent.

2. A composition according to claim 1 wherein the hydrogenated carboxylated nitrile rubber has a nitrile content in the range of from 18 to 45 wt %, an acid monomer content in the range of from 0.3 to 9 wt %, an RDB not greater than 9.0% and a Mooney viscosity in the range of from 35 to 120 (ML 1+4′@100° C.).

3. A composition according to claim 1 wherein the hydrogenated carboxylated nitrile rubber is comprises an acrylonitrile, 1,3-butadiene and an acrylic acid.

4. A composition according to claim 1 further comprising at least one carboxylated nitrile rubber.

5. A composition according to claim 1 further comprising at least one nitrile rubber.

6. A composition according to claim 1 wherein the multivalent salt is zinc diacrylate.

7. A composition according to claim 1 wherein the vulcanizing agent is a peroxide.

8. A composition according to claim 1 wherein carbon black is the filler.

9. A vulcanized composition comprising at least one hydrogenated carboxylated nitrile rubber, at least one hydrogenated nitrile rubber, at least one filler, at least one multivalent salt of an organic acid and at least one vulcanizing agent.

10. A vulcanized composition according to claim 9 in the form of a pad for the track of a tracked vehicle.

11. A process for preparing a composition composing of at least one hydrogenated carboxylated nitrile rubber, at least one hydrogenated nitrile rubber, at least one filler, at least one multivalent salt of an organic acid and at least one vulcanizing agent which comprises the steps of blending at least one hydrogenated carboxylated nitrile rubber, at least one hydrogenated nitrile rubber, at least one filler, at least one multivalent salt of an organic acid and at least one vulcanizing agent.
